(19) United States
(12) Patent Application Publication
(10) Pub. No.: US 2018/0258004 A1
(43) Pub. Date: Sep. 13, 2018

(54) USE OF PHLOROTANNINS AS A STIMULANT FOR MYCHORRHIZAL AND RHIZOBIAL SYMBIOSES

(71) Applicant: Agro Innovation International, Saint Malo (FR)

(72) Inventors: Xavier BRIAND, Lezardrieux (FR); Sylvia Céline SALAMAGNE, Langueux (FR)

(73) Assignee: Agro Innovation International, Saint Malo (FR)

(21) Appl. No.: 15/754,741

(22) PCT Filed: Aug. 26, 2016
(86) PCT No.: PCT/FR2016/052127

§ 371 Date: Feb. 23, 2018

(30) Foreign Application Priority Data
Aug. 26, 2015 (FR) 1557940
May 20, 2016 (FR) 1654516

(51) Int. Cl. C05F 11/00; A01N 65/03; C05G 3/00; A01N 25/12

(52) U.S. Cl. CPC C05F 11/00; A01N 25/12; C05G 3/0058; A01N 65/03

(57) ABSTRACT

The invention relates to the use of phlorotannins, particularly extracts of brown algae from the Fucaceae family, particularly of the Fucus or Ascophyllum genus, for stimulating the symbiosis between a plant and a mycorrhizal fungus or a rhizobium. The invention also relates to a fertilizing product containing phlorotannins and to the uses thereof in a plant treatment method.

The subject of the present invention, which is of use in the agricultural field, is essentially the use of phlorotannins, in particular extracted from brown algae, in particular of the family Fucaceae, in particular of the Fucus or Ascophyllum genus, for stimulating the symbiosis between a plant and a mychorrhizal fungus.

Phlorotannins are a type of tannin that is found in the cell wall of brown algae. These compounds are phloroglucinol oligomers.

The subject of the present invention is also fertilizing compositions such as, for example, fertilizers containing phlorotannins, and also a method for treating plants or soils using same.

In the context of the present invention, the expression “fertilizing composition” is intended to denote any products of which the use is intended to ensure or improve the physical, chemical or biological properties of soils and also plant nutrition.

Such a composition can for example be a fertilizer applied via the roots.

It is known that fertilizers are defined as fertilizing materials of which the main function is to provide plants with the elements directly useful for their nutrition (major fertilizing elements, secondary fertilizing elements and trace elements).

To this effect, root fertilizers generally use sources of nitrogen, phosphorus and potassium and also trace elements and amino acids.

It is known that plants are capable of developing symbiotic associations with microorganisms, so as to allow the efficient acquisition of nutrients by the plant. Among the most economical and most ecological symbiotic associations, mention may be made of interactions between plants and mychorrizal fungi or between leguminous plants and nitrogen-fixing bacteria known as rhizobia.

### Plant-Mychorrhizal Fungi Symbiosis

Mycorrhizal fungi are capable of forming a close symbiosis with plant roots. They associate with more than 90% of plant species, such as cereals, grazing, potato, corn, sunflower, cotton, coffee tree, fruit trees, sugarcane, leguminous plants, ornamental plants. This symbiosis is absent in some species, for instance rapeseed, cabbage and sugar beet. The result of the symbiotic association between a mycorrhizal fungus and a plant root is called mycorrhiza.

Mychorrhizal fungi colonize the root system of the plant. They are considered to be extensions of the roots of the plant. This network of filaments connected to the roots of the plant in the form of a network acts as telescopic arms which draw up the nutrients from the soil. This filament network allows the plant to increase its root exploratory capacity and thus makes it possible to have access to the nutritive elements inaccessible via the root system of the plant. The plant-mychorrhizal fungi symbiosis results in an improvement in the efficiency of fertilizers and a reduction in the losses due to leaching or erosion.

In return, the plant provides the mychorrhizal fungus with the sugars required for its growth and for the synthesis of glomalin by the filament network of the mycorrhiza. Glomalin is a glycoprotein which is excreted by the filament network and which participates in the structure of the soil and in the improvement of the organic matter content of the soil. Indeed, mychorrhizal fungi, through the production of glomalin, facilitate phytostabilization by creating a natural barrier which induces resistance to erosion and to leaching. They can also be used to minimize soil contamination with metals.

There are many agronomical effects associated with the stimulation of the symbiosis between a plant and a mychorrhizal fungus. The stimulation of the symbiosis between a plant and a mychorrhizal fungus makes it possible in particular:
to optimize the efficiency of fertilizers
to improve the accessibility to fertilizing elements that are not very mobile, such as phosphorus
to stimulate plant growth, flowering and/or fruiting
to improve harvest yield and quality
to improve tolerance to soil salinity
to improve resistance to climatic stresses, in particular drought or heat stress
to reduce crop sensitivity to pathogens and to nematodes
to reduce losses due to leaching and erosion
to improve the soil structure.

The degree of mycorrhization of a crop appears to be a factor that influences the yield and quality of agricultural products with an impact on protection of the environment. The degree of mycorrhization is determined on the basis of observation of the colored roots and of counting of the points with the presence of a hypha or on the basis of counting the number of spores or of clusters.

Particularly low degrees of mycorrhization are today observed in soils because of various crop practices, such as the bulk use of fertilizers and of pesticides, monoculture, the absence of rotation, the development of non-mycorrhizal crops (rapeseed, sugar beet, cabbage, etc.) or intensive working techniques.

### Leguminous Plant-Rhizobia Symbiosis

Rhizobia (genus Rhizobium), are aerobic bacteria of the soil, belonging to the family Rhizobiaceae. The symbiosis between a leguminous plant and a rhizobium is a process essential to the plant for acquiring nitrogen in reduced form, but also to the rhizobia for obtaining the nutrients required for their development. The leguminous plant provides the rhizobium with nutritive materials, and said rhizobium takes up nitrogen from the air and gives it to its host. This symbiosis results in the formation of new organs called root nodules. Root nodules are small swellings which form on the roots under the action of the rhizobia. These root nodules lodge inside the endosymbiotic rhizobia of the leguminous plant cells, which reduce atmospheric nitrogen to ammonium. This reduced nitrogen is transferred to the plant and used for its growth. The symbiotic nitrogen fixing considerably improves the plant's nitrogen supply. These rhizobia are therefore considerably important since they can fix up to 350 kg/ha/year of nitrogen. As for the symbiosis between a plant and a mychorrhizal fungus, crop practices can also affect the formation of the symbiosis between a leguminous plant and a rhizobium. This can result in a decrease in root nodule formation.

There is therefore a considerable need for new fertilizer products which make it possible to make good the plant's deficiencies, in particular by stimulating the symbiosis between a plant and a mychorrhizal fungus and the symbiosis between a leguminous plant and a leguminous plant.

Marine algae constitutes an abundant plant resource and have for a long time been used on coastal regions as soil fertilizers. The germination of seeds, the obtaining of better yields, disease resistance, a longer shelf life for fruits have been demonstrated following treatments of several plants with extracts of algae. The conclusions in terms of plant growth and health had essentially been attributed to the richness in betains, in phytohormones, in polysaccharides and in trace elements of the algae used.

It is in this context that the applicant has demonstrated, and this constitutes the base of the present invention, that phlorotannins, in particular extracted from brown algae of the family Fucaceae, make it possible entirely surprisingly and unexpectedly to stimulate mychorrhizal and rhizobial symbioses. This strong activity is supported by a stimulation of sporulation and of nodulation.

These phlorotannins can therefore be used as a supplement in fertilizing compositions such as fertilizers, as spore- and nodule-formation activators.

Such compositions allow an increased increase in the absorption of the nutritive elements from the soil and in the health of the plant, meeting the growth needs of the crop, which will be expressed in particular in terms of improvement in harvest yield and quality.

These compositions also make it possible to improve fertilizing efficiency and to reduce losses due to leaching and problems of erosion.

Thus, according to the first aspect, the present invention aims to cover the use of phlorotannins, in particular extracted from brown algae of the family Fucaceae, for stimulating the symbiosis between a plant and a mychorrhizal fungus.

The phlorotannins that are used according to the invention are polyphenols specifically present in the cell walls and the cells of brown algae of the family Fucaceae.

Phlorotannins represent between 5 and 200 mg/g of the dry weight of the alga.

In one particular embodiment, the plant is a leguminous plant.

Leguminous plants belong to the family Fabaceae. Leguminous plants play an important role in the food sector by virtue of their high content of proteins and of essential amino acids. Nonlimiting examples of leguminous plants are soya, peanut, bean, pea, lentil, chickpea, broad bean, horse bean, vetch, everlasting pea, alfalfa, clover, lupin, mungo bean (germinated soya shoots), licorice, rosewood, birdsfoot trefoil, French honeysuckle, rooibos and fenugreek.

In one particular embodiment, the phlorotannins also make it possible to stimulate the symbiosis between a leguminous plant and a rhizobium. Preferably, the stimulation of the symbiosis between a leguminous plant and a rhizobium adds to the stimulation of the symbiosis with a mychorrhizal fungus. The present application also aims to cover the use of phlorotannins, in particular extracted from brown algae of the family Fucaceae, for stimulating the symbiosis between a leguminous plant and a rhizobium.

Advantageously, the phlorotannins used according to the present invention are extracted from algae chosen from the group consisting of species of the Fucus and Ascophyllum genera, in particular chosen from the group consisting of the Fucus vesiculosus, Fucus serratus and Ascophyllum nodosum species.

Extracts of algae rich in phlorotannins that can be used in the context of the present invention can be obtained from the abovementioned species of algae by means of a method generally comprising the following steps: washing, grinding, extraction (solid-liquid separation) and optionally fractionation in concentration.

The extract obtained can be more or less concentrated depending on the use envisioned. Total dehydration of this extract allowing a presentation in water-soluble pulverulent form can be obtained, for example, by means of a drum dryer or by spray-drying.

The extraction conditions and the nature of the algae will be chosen such that the extract obtained has the concentration desired in the application envisioned. It will be possible for these choices to be easily made by those skilled in the art, in particular by taking into account the general indications that will follow.

Generally, the amount of phlorotannins provided to plants is from 10 to 1000 g/ha and preferably about 100 g/ha for provisions in solid form in pulverulent or granulated fertilizers.

In one particular embodiment, the phlorotannins also make it possible to stimulate the absorption in the plant of one or more elements chosen from nitrogen, phosphorus, potassium and calcium. For the purposes of the invention, the term “stimulating the absorption” is intended to mean an increased increase in the absorption, and/or an improvement in the absorption mechanisms. Thus, in one particular embodiment, the phlorotannins also make it possible to stimulate the mechanisms of absorption in the plant of one or more elements chosen from nitrogen, phosphorus, potassium and calcium. In the context of the present invention, an effective amount of phlorotannin is provided to the plant for stimulating the absorption of one or more elements chosen from nitrogen, phosphorus, potassium and calcium. Thus, in one particular embodiment, the phlorotannins are provided to the plant in an effective amount for increasing the absorption by the plant of one or more abovementioned elements by at least 5%, for example by at least 10%, by at least 15%, by at least 20%, by at least 25%, by at least 30%, by at least 40%, for example by at least 50%. In other words, the phlorotannins provided to the plant make it possible to increase the content in the plant of one or more abovementioned elements by at least 5%, for example by at least 10%, by at least 15%, by at least 20%, by at least 25%, by at least 30%, by at least 40%, for example by at least 50%.

The increase in the absorption is measured by determining the nitrogen, phosphorus, potassium and/or calcium content in the plant. The term “increase” is intended to mean compared with the plant before the provision of phlorotannins, for example compared with the plant having received no provision of the phlorotannins. The nitrogen, phosphorus, potassium and/or calcium “content” is expressed in w/w of dry weight, which corresponds to the weight of nitrogen, phosphorus, potassium and/or calcium contained in a dried plant sample. The measurement of the nitrogen, phosphorus, potassium and/or calcium content is carried out by an appropriate analysis method.

The present invention also aims to protect the use of phlorotannins, in particular extracted from brown algae of the family Fucaceae, for stimulating the absorption in a plant of one or more elements chosen from nitrogen, phosphorus, potassium or calcium. In one particular embodiment, the phlorotannins are provided to the plant in an effective amount for increasing the absorption by the plant of one or more abovementioned elements by at least 5%, for example by at least 10%, by at least 15%, by at least 20%, by at least 25%, by at least 30%, by at least 40%, for example by at least 50%. In other words, the phlorotannins provided to the plant make it possible to increase the content in the plant of one or more abovementioned elements by at least 5%, for example by at least 10%, by at least 15%, by at least 20%, by at least 25%, by at least 30%, by at least 40%, for example by at least 50%.

According to a second aspect, the present application aims to protect a method for stimulating the symbiosis between a plant and a mychorrhizal fungus, characterized in that it comprises the application, to said plant to or the soils, of an effective amount of phlorotannins, in particular extracted from brown algae of the family Fucaceae.

In one particular embodiment, the plant is a leguminous plant. Thus, the method according to the present invention also makes it possible to stimulate the symbiosis between a leguminous plant and a rhizobium. Preferably, the stimulation of the symbiosis between a leguminous plant and a rhizobium adds to the stimulation of the symbiosis with a mychorrhizal fungus.

The present invention also aims to cover a method for stimulating the symbiosis between a leguminous plant and a rhizobium, characterized in that it comprises the application, to said plant or to the soils, of an effective amount of phlorotannins, in particular extracted from brown algae of the family Fucaceae.

Advantageously, the application to the plants will be carried out via the roots.

The effective amount of phlorotannins provided to the plants is from 0.1 g to 100 g per liter and preferentially about 5 g per liter for the provisions in liquid form in the root nutritive solutions (hydroponics, dropwise, etc.) or else from 10 to 1000 g/ha and preferentially about 100 g/ha for the provisions in solid form in pulverulent or granulated fertilizers.

In one particular embodiment, the phlorotannins also make it possible to stimulate the absorption in the plant of one or more elements chosen from nitrogen, phosphorus, potassium and calcium.

The present invention also aims to protect a method for stimulating the absorption in a plant of one or more elements chosen from nitrogen, phosphorus, potassium and calcium, characterized in that it comprises the application, to said plant or to the soils, of an effective amount of phlorotannins, in particular extracted from brown algae of the family Fucaceae.

In one embodiment, the phlorotannins are applied to the plant or to the soils in an effective amount for increasing the absorption by the plant of one or more abovementioned elements by at least 5%, for example by at least 10%, by at least 15%, by at least 20%, by at least 25%, by at least 30%, by at least 40%, for example by at least 50%. In other words, the phlorotannins applied to the plant or to the soils make it possible to increase the content in the plant of one or more abovementioned elements by at least 5%, for example by at least 10%, by at least 15%, by at least 20%, by at least 25%, by at least 30%, by at least 40%, for example by at least 50%. According to a third aspect, the present application aims to protect a fertilizing product, characterized in that it comprises an effective amount of phlorotannins, in particular extracted from brown algae of the family Fucaceae, optionally in combination with one or more fertilizing substances. Advantageously, the fertilizing product is characterized in that it is:
either in liquid form and in that it contains an amount of phlorotannins of from 0.1 to 100 g per liter, and preferably of about 5 g per liter;
or in solid form, in particular in powder or granule form, and in that it contains an amount of phlorotannins which allows a provision of from 10 to 1000 g and preferably of about 100 g per hectare.

Advantageously, the fertilizing product according to the invention is in various forms, for instance:
an amendment, in particular lime or manure,
a fertilizer, in particular a root fertilizer,
a nutritive solution, in particular a root nutritive solution.

In one particular embodiment, the fertilizing product comprises an effective amount of phlorotannins, in particular extracted from brown algae of the family Fucaceae, in combination with one or more fertilizing substances. Advantageously, the fertilizing substance is a calcium source, in particular calcium carbonate, calcium sulfate, gypsum and/or phosphogypsum. In particular, the combination of the phlorotannins and of the calcium source, in particular calcium carbonate, makes it possible to optimally stimulate the symbiosis between the plant and the mychorrhizal fungus.

By way of example of fertilizing products in accordance with the invention, mention will be made of limes, manures and crop supports, root fertilizers of NP, PK, NPK type, etc., or else root nutritive solutions.

The fertilizing substances that can be used in combination with the phlorotannins may be of varied natures and chosen for example from urea, ammonium sulfate, ammonium nitrate, natural phosphate, potassium chloride, ammonium sulfate, magnesium nitrate, manganese nitrate, zinc nitrate, copper nitrate, phosphoric acid and boric acid.

The present invention is of use in the treatment of a very large variety of plants.

Among said plants, mention will particularly be made of:
large crop plants such as cereals (wheat, corn, sugar cane, etc.),
protein-yielding plants (pea),
oleaginous plants (soya, sunflower),
grapevine,
prairial plants used for animal feed,
specialized crops such as, in particular, crops for market gardening (lettuce, spinach, tomato, melon), grapevine, tree cultivation (orange, pear, apple, nectarine) or horticulture (rose bushes).

The expression “plant” is intended to denote, in the present application, the plant considered as a whole, including its root system, its vegetable system, the grains, seeds and fruits.

The present invention will now be illustrated by means of the following nonlimiting examples.

In these examples, and unless otherwise indicated, the percentages are expressed by weight and the temperature is ambient temperature.

### EXAMPLE 1—METHOD FOR PREPARING PHLOROTANNINS THAT CAN BE USED IN THE CONTEXT OF THE INVENTION

### A—General Description

a) Preparation of an Extract of Phlorotannins from Ascophyllum nodosum

The phlorotannin fraction was obtained by aqueous extraction of fresh algae (200 g of Ascophyllum nodosum per liter of water).

The extraction is an acid hydrolysis (pH 3) which was carried out with stirring for 48 h, with heating for 1 h at 90-100° C. The extract was then filtered through a membrane (80 μm pore size).

b) Preparation of an Extract of Phlorotannins from Fucus Vesiculosus

The phlorotannin fraction was obtained by aqueous extraction of fresh algae (200 g of Fucus vesiculosus per liter of water).

The extraction is an acid hydrolysis (pH 3) which was carried out with stirring for 48 h at ambient temperature. The extract was filtered through a membrane (80 μm pore size). The solvent (water) was evaporated off so as to obtain a water-soluble powder.

### B—Detailed Example of Preparation of an Extract of Phlorotannins:

An extract of phlorotannins was obtained following the experimental protocol below:

### a) Washing

Fresh algae of Ascophyllum nodosum or Fucus vesiculosus type was subjected to two successive washes in a tank of water in order to remove the sand and gravel.

### b) Grinding

The algae thus washed were drained and then ground into pieces of 1 to 10 mm.

### c) Extraction

200 kg of algae were dispersed in a heating reactor containing 1000 kg of an aqueous solution maintained at ambient temperature (Fucus vesiculosus) or brought to a temperature of 90° C. (Ascophyllum nodosum). The whole mixture was kept stirring for a period of approximately 48 hours and 2 hours, respectively.

Prior to the extraction, the already ground algal cells were micro-burst by means of a homogenizer of Ultra-Turrax® type in order to promote the extraction. The separation operation is carried out at the end of the extraction steps.

### d) Separation

The phlorotannin-rich soluble fraction was separated from the algal debris by centrifugation (solid-liquid separation).

The centrifuged extract was then filtered either through a diatomaceous earth filter or through a plate filter, and then again filtered through a membrane of up to 1 μm.

The filtrate thus obtained comprises between 0.1% and 10% by weight of dry extract.

The extract thus prepared can be used in a more or less concentrated form, the final concentration being determined as a function of the desired content of active derivatives in the application envisioned.

Thus, the abovementioned filtrate can be concentrated, for example, by means of a falling film evaporator, such that the dry extract represents from 10% to 60% by weight of said filtrate.

A complete dehydration can also be obtained, for example, by means of a drum dryer or by spray-drying when a presentation in water-soluble pulverulent form is desired.

By performing the process as described above, various extracts of phlorotannins were prepared from 2 species of brown algae of the Ascophyllum or Fucus genera. The composition of these dry extracts of phlorotannins is given in table 1 below.

TABLE 1
Composition of the extracts of
phlorotannins of brown algae

| | Phlorotannin content |
|---|---|
| ALGA | (% dry extract) |
| FUCUS vesiculosus | 22.8 |
| ASCOPHYLLUM nodosum | 15.3 |

### EXAMPLE 2—EFFECTS OF AN EXTRACT OF PHLOROTANNINS ON THE SPORULATION OF RHIZOPHAGUS INTRARADICES AND ON THE PRODUCTION OF BIOMASS IN CORN

Pre-germinated corn seeds were sown in a 0.9 l pot, in a proportion of one seed per pot. The pots were prefilled with a cultivation support inoculated with a mychorrhizal fungus, Rhizophagus intraradices. The plants were cultivated for 8 weeks under controlled conditions. The plants were watered 3 times a week with osmotically treated water for the control modality and with osmotically treated water for the first week and then with the extract of phlorotannins produced according to example 1, diluted in water (in a proportion of 100 g/ha of phlorotannins) for the treated modality. The control and the modality were watered with osmotically treated water for the first week. Starting from the second week, the osmotically treated water was replaced with the extract of phlorotannins. The provision of fertilizer was carried out starting from the third week with a 15/3/25 fertilizer, corresponding to the Nitrogen/Phosphorus/Potassium content respectively, at a rate of one provision per week in the watering water. Two extracts of phlorotannins were tested: one derived from Ascophyllum nodosum (AN extract) and another derived from Fucus vesiculosus (FV extract).

The controls and the sporulation of Rhizophagus intraradices were carried out after 6 and 8 weeks of cultivation. For each control, 5 plants per modality were analyzed. For each plant, the fungal material was extracted. The spore clusters were counted under a binocular magnifying lens.

For the FV extract, measurements of aerial and root biomasses of the corn plants were carried out after 8 weeks of cultivation. 5 plants per modality were analyzed.

The two extracts of phlorotannins have a significant effect on the number of spore clusters and the number of spores per cluster of Rhizophagus intraradices. The application of the FV extract also allows an increase in the fresh material of the aerial and root parts of the corn plants.

TABLE 2
Effect of 2 extracts of phlorotannins on the
number of Rhizophagus intraradices spore clusters

| | Average number of spore clusters per plant | | | |
|---|---|---|---|---|
| | FV extract | | AN extract | |
| | 6 weeks | 8 weeks | 6 weeks | 8 weeks |
| Control | 28 | 60 | 28 | 60 |
| Treated | 73 | 205 | 114 | 191 |
| Index | 260.7% | 341.7% | 407.1% | 318.3% |

The results presented in table 2 show a clear increase in the average number of spore clusters for the plants treated with the phlorotannins, compared with the control plants.

TABLE 3
Effect of an extract of phlorotannins derived from Fucus vesiculosus
on the number of Rhizophagus intraradices spores per cluster

| | | <10 | 10-19 | 20-29 | 30-39 | 40-49 | >50 |
|---|---|---|---|---|---|---|---|
| 6 weeks | Control | 37 | 27 | 17 | 11 | 3 | 5 |
| | Treated | 28 | 45 | 14 | 8 | 4 | 1 |
| 8 weeks | Control | 50 | 27 | 11 | 8 | 1 | 3 |
| | Treated | 35 | 43 | 12 | 8 | 0 | 2 |

The results presented in table 3 show an increase in the number of clusters with more than 10 spores for the plants treated with the phlorotannins derived from Fucus vesiculosus, compared with the control plants.

TABLE 4
Effect of an extract of phlorotannins derived from Ascophyllum
nodosum on the number of Rhizophagus intraradices spores per cluster

| | | <10 | 10-19 | 20-29 | 30-39 | 40-49 | >50 |
|---|---|---|---|---|---|---|---|
| 6 weeks | Control | 37 | 27 | 17 | 11 | 3 | 5 |
| | Treated | 16 | 42 | 19 | 7 | 7 | 9 |
| 8 weeks | Control | 50 | 27 | 11 | 8 | 1 | 3 |
| | Treated | 31 | 45 | 13 | 6 | 1 | 4 |

The results presented in table 4 show an increase in the number of clusters with more than 10 spores for the plants treated with the phlorotannins derived from Ascophyllum nodosum, compared with the control plants.

TABLE 5
Effect of an extract of phlorotannins derived from
Fucus vesiculosus on the growth of corn plants

| | Control | Treated |
|---|---|---|
| Average fresh weights of aerial parts (in g) | 14.84 | 25.03 |
| Average dry weights of aerial parts (in g) | 1.63 | 2.75 |
| Fresh weights of root parts (in g) | 3.33 | 4.49 |

The results presented in table 5 show that the plants treated with the phlorotannins derived from Fucus vesiculosus have developed more rapidly, both for the aerial parts and for the root parts, compared with the control plants.

The results presented in this example clearly show that the phlorotannins made it possible to strongly stimulate the symbiosis between the corn plants and Rhizophagus intraradices and thus to stimulate the growth of the plant.

### EXAMPLE 3—EFFECT OF AN EXTRACT OF PHLOROTANNINS FROM FUCUS VESICULOSUS ON THE MINERAL ELEMENT CONTENT OF THE AERIAL PARTS OF CORN PLANTS

Pre-germinated corn seeds were sown in a 0.9 l pot, in a proportion of one seed per pot. The pots were prefilled with a cultivation support inoculated with a mychorrhizal fungus, Rhizophagus intraradices. The plants were cultivated for 8 weeks under controlled conditions. The plants were watered 3 times a week with osmotically treated water for the control modality and with osmotically treated water for the first week and then with the extract of phlorotannins derived from Fucus vesiculosus (produced according to example 1), diluted in water (in a proportion of 100 g/ha of phlorotannins), for the treated modality. The control and the treated modality were watered with osmotically treated water for the first week. Starting from the second week, the osmotically treated water was replaced with the extract of phlorotannins for the treated modality. The provision of fertilizer was carried out starting from the third week with a 15/3/25 fertilizer, corresponding to the Nitrogen/Phosphorus/Potassium content respectively, at a rate of one provision per week in the watering water.

The nitrogen, phosphorus, potassium and calcium contents of the aerial parts of the corn plants were measured after 8 weeks of cultivation. Five plants per modality were used. Before analyses, the aerial parts were dried in an oven and then ground. The total nitrogen content was measured according to the principle of the Dumas method, which consists of combustion at 1200° C. under oxygen, purification of the combustion gases, conversion of the nitrogen oxides produced into elemental nitrogen and quantitative determination of the elemental N by katharometry. The total phosphorus, total potassium and total calcium contents were measured by dry mineralization (according to the Maurice Pinta method, atomic absorption spectrometry: application to chemical analysis, 1979). The dry plant sample is ground and calcined in a muffle furnace, then the ashes are taken up with concentrated hydrochloric acid. The extract is evaporated to dryness and then taken up with dilute hydrochloric acid. The quantitative determination is carried out on the diluted extract brought to volume, by optical plasma emission spectrometry (ICP AES).

The application of the FV extract allows an increase in the nitrogen, phosphorus, potassium and calcium content of the aerial parts of the corn plants.

TABLE 6
Effect of an extract of phlorotannins of Fucus vesiculosus on the
mineral element contents of the aerial parts of corn plants.

| Elements (% w/w of dry weight) | Control | FV extract |
|---|---|---|
| Total nitrogen | 2.97 | 3.4 |
| Total phosphorus | 0.19 | 0.25 |
| Total potassium | 4.69 | 4.99 |
| Total calcium | 0.43 | 0.49 |

The results presented are expressed as a percentage of the weight of the mineral element relative to the dry weight (% w/w of dry weight), for example in grams of mineral element/100 g of dry weight. In this case, this corresponds to the percentage of nitrogen, phosphorus, potassium and calcium in a dried sample of aerial parts of corn plants. The results presented in table 6 show an increase in the content of mineral elements (nitrogen, phosphorus, potassium and calcium) of the aerial parts of the plants treated with the phlorotannins derived from Fucus vesiculosus, compared with the control plants.

### EXAMPLE 4—EFFECTS OF AN EXTRACT OF PHLOROTANNINS ON THE FORMATION OF RHIZOBIAL NODULES

The experiment was carried out on forage pea of the Solara variety. The forage pea was sown in a proportion of 15 seeds per pot, equivalent to a sowing density of 590 seeds/m². The pots contain a mixture of enriched peat, of earth and of sand (⅓, ⅓, ⅓). Each modality consists of 8 pots.

An inert support onto which has been added the extract of phlorotannins produced according to example 1 from Fucus vesiculosus was mixed into the soil in a proportion of 100 kg/ha (which is equivalent to 100 g/ha of phlorotannins). For the control, the extract was replaced with water. The cultivations were carried out for 5 weeks. After 5 weeks of cultivation, the number of nodules and the solids content of the aerial parts were determined.

A 37% increase in the number of nodules compared with the control is observed. At the same time, the production of solids by the aerial parts is increased by 9% compared with the control.

TABLE 7
Effects of an extract of phlorotannins on the nodule formation

| | Number of | % | SC aerial | % |
|---|---|---|---|---|
| | nodules | Control | parts | Control |
| Control | 29 | | 0.43 g | |
| Extract | 40 | +37% | 0.47 g | +9% |

SC: Solids Content

The results presented in this example clearly show that the phlorotannins made it possible to strongly stimulate the symbiosis between the corn plants and a Rhizobium and thus to stimulate the growth of the plant.

### EXAMPLE 5—EFFECTS OF AN EXTRACT OF PHLOROTANNINS ON WHEAT YIELD

The test was carried out on wheat of the Altria variety, sown at a density of 160 kg/ha.

The experimental scheme comprises modalities with 4 repetitions. Each elementary plot measures 7 m×2 m, that is to say a surface area of 14 m². The nitrogenous fertilization (165 U, slightly limiting dose X-10%) was fractionated into 3 provisions of ammonium nitrate 33.5. The provisions were supplied at the tillering (55 U), 1 cm ear (85 U) and last visible leaf (25 U) stage.

The extract of phlorotannins produced according to example 1 from Ascophyllum nodosum was applied at the mid-earing stage in a proportion of 150 g/ha.

The soil was of clayey-sandy Limon type with a pH at 8.1.

TABLE 8
Effects of an extract of phlorotannins from
Ascophyllum nodosum on wheat yield

| | Yield at | % |
|---|---|---|
| | 14.5% (q/ha) | Control |
| Control | 60.11 | |
| Extract | 66.32 | +10.3% |

The yield is expressed relative to a solids content of 14.5%.

q/ha: quintals per hectare

The extract of phlorotannins enables an improvement in the yield of 6.2 q/ha, that is to say an increase of 10.3%.

### EXAMPLE 6—EFFECTS OF AN EXTRACT OF PHLOROTANNINS ON SOYA FRUITING

The experiment was carried out on a soya crop. The soya was sown at a density of 70 seeds/m².

The extract of phlorotannins produced according to example 1 from Fucus vesiculosus was applied in a proportion of 100 g/ha in two stages (2-3 leaves and beginning of flowering).

The results are given in table 9.

TABLE 9
Effects of an extract of phlorotannins on the number of beans

| | Beans/plant | % Control | SC/plant (g) | % Control |
|---|---|---|---|---|
| Control | 7.17 | | 11.30 | |
| Extract | 8.26 | +15.2% | 12.26 | +8.5% |

SC = Solids Content

The extract of phlorotannins promotes the vegetative development of the plant and also the formation of beans.

### EXAMPLE 7—EFFECTS OF AN EXTRACT OF PHLOROTANNINS ON PEAR PRODUCTION AND QUALITY

The test was carried out on an orchard of pear trees of the Williams variety planted at a density of 3000 trees per hectare. The orchard was managed in a hedge system.

The modalities are composed of 4 elementary plots, each corresponding to a row of 5 trees.

The extract of phlorotannins produced according to example 1 from Fucus vesiculosus was provided in a proportion of 300 g/ha at the beginning of the flowering stage; the amount of open flowers was estimated at greater than 3%.

The pear harvest was carried out on 4 trees per elementary plot, that is to say 16 trees per modality. The tree on the border between 2 treatments was not taken into account. In order to determine the average weight of a fruit, 100 fruits per repetition were weighed. The firmness was determined on 20 fruits per repetition. The firmness was determined using a penetrometer which measures the force required to make a metal cylinder penetrate into the fruit. In this test, the metal cylinder is a 0.5 cm² mobile nozzle. The results were therefore expressed in kg/0.5 cm² and are given in table 10.

TABLE 10
Effects of an extract of phlorotannins on pear production

| | Harvest | % | Average weight | Firmness of |
|---|---|---|---|---|
| | (kg) | Control | of 100 fruits (kg) | 20 fruits (kg) |
| Control | 148 | | 23.7 | 8.0 |
| Extract | 157.2 | +6.2% | 24.6 | 8.2 |

A 6.2% increase in the yield, with a slight superiority in qualitative terms (average weight and firmness of the fruits), is observed for the pear trees treated with the extract of phlorotannins.

### EXAMPLE 8—EFFECTS OF AN EXTRACT OF PHLOROTANNINS ON MELON PRODUCTION

The experiment was carried out in a heated tunnel irrigated with a plastic soil mulch. The melon plants with a ball of earth around the roots (Preco variety grafted onto Tézier stock), grown in a nursery, were replanted at the 2 true leaf stage.

The plants were managed on 2 primary shoots. They were headed at approximately 8 foliar stages. The secondary shoots formed were then pruned at 2 leaf stages.

Each elementary plot comprises 15 plants on one row. The modalities are composed of 4 repetitions.

The extract of phlorotannins produced according to example 1 from Ascophyllum nodosum was provided in a proportion of 100 g/ha.

The results are given in table 11.

TABLE 11
Effects of an extract of phlorotannins on melon production

| | Cumulative | | Cumulative | |
|---|---|---|---|---|
| | weight (kg/ | % | number (/60 | % |
| | 60 plants) | Control | plants) | Control |
| Control | 255 | | 426 | |
| Extract | 294.1 | +15.3% | 500 | 17.4% |

The results show that the melons treated with the extract of phlorotannins showed an early production. Furthermore, the harvests were larger from the first days and the differential was maintained up to the final day of harvest with an increase of 15.3% in the cumulative weight and of 17.4% in the number of melons.

### EXAMPLE 9—EXAMPLES OF FORMULATIONS INCORPORATING EXTRACTS OF PHLOROTANNINS

Various fertilizing products that may be used according to the invention will be given hereinafter by way of examples, with indications regarding the conditions for using them.

### A—Amendments

### A) Lime

| Amendment 1 | | |
|---|---|---|
| Lithothamnium | 1000 | kg |
| Extract of phlorotannins | QS 200 | g/ha |
| Provision dose 1 T/ha | | |
| Amendment 2 | | |
| Calcium carbonate | 1000 | kg |
| Extract of phlorotannins | QS 1000 | g/ha |
| Provision dose 1 T/ha | | |
| Amendment 3 | | |
| Gypsum | 1000 | kg |
| Extract of phlorotannins | QS 1000 | g/ha |
| Provision dose 1 T/ha | | |

T/ha: tonnes per hectare

### b) Manure and Crop Supports

| | | |
|---|---|---|
| Compost | 500 | kg |
| Peat | 500 | kg |
| Extract of phlorotannins | QS 500 | g/ha |
| Provision dose 1 T/ha | | |

### B—Root Fertilizers

### A) NP Fertilizer

| | | |
|---|---|---|
| Lithothamnium | 310 | kg |
| Potassium chloride | 167 | kg |
| Urea | 161 | kg |
| Ammonium sulfate | 362 | kg |
| Extract of phlorotannins | QS 200 | g/ha |

| CROPS | PROVISION DOSE (kg/ha) |
|---|---|
| Grazing | |
| Cereals | 200-400 |
| Corn | |

### b) NPK Fertilizer+MgO

| | | |
|---|---|---|
| Lithothamnium | 158 | kg |
| Ammonium phosphate | 116 | kg |
| Ammonium sulfate | 186 | kg |
| Urea | 156 | kg |
| Magnesium oxide | 50 | kg |
| Potassium chloride | 334 | kg |
| Extract of phlorotannins | QS 1000 | g/ha |

| CROPS | PROVISION DOSE (kg/ha) |
|---|---|
| Corn | |
| Cereals | 400-800 |
| Meadows | |
| Any crops | |

### C—Root Nutritive Solutions (Hydroponics, Dropwise)

### A) Solution NPK Mg

| | | |
|---|---|---|
| Potassium nitrate | 50 | g/l |
| Potassium phosphate | 27 | g/l |
| Magnesium sulfate | 49 | g/l |
| Extract of | 200 | g/l |

| | |
|---|---|
| phlorotannins | (i.e. 1 g/l of final |
| | solution applied to the plant) |

Dilution 1 l per 200 l of water

### b) Solution N Ca Mg

| | | |
|---|---|---|
| Calcium nitrate | 118 | g/l |
| Iron chelate | 5 | g/l |
| Extract of | 100 | g/l |

| | |
|---|---|
| phlorotannins | (i.e. 0.5 g/l of final |
| | solution applied to the plant) |

Dilution 1 l per 200 l of water

1.-15. (canceled)

16. A method for stimulating the symbiosis between a plant and a mychorrhizal fungus, comprising application to said plant or to the soils of an effective amount of phlorotannins, in particular extracted from brown algae of the family Fucaceae.

17. The method as claimed in claim 16, wherein the phlorotannins are extracted from algae species of the Fucus or Ascophyllum genus.

18. The method as claimed in claim 16, wherein the phlorotannins extracts are obtained by washing, grinding, extraction (solid-liquid separation) and optionally fractionation and concentration.

19. The method as claimed in claim 16, wherein the plant is a leguminous plant.

20. The method as claimed in claim 16, wherein it also makes it possible to stimulate the symbiosis with a rhizobium.

21. The method as claimed in claim 16, wherein the application is carried out via roots of the plant.

22. The method as claimed in claim 16, wherein the phlorotannins are used in an amount:
of from 0.1 to 100 g per liter for application in liquid form in root nutritive solutions,
of from 10 to 1000 g for the application in solid form, for example in pulverulent or granulated fertilizers.

23. The method as claimed in claim 16, wherein the phlorotannins are used in an amount:
of about 5 g per liter for application in liquid form in root nutritive solutions,
of about 100 g per hectare for application in solid form, for example in pulverulent or granulated fertilizers.

24. The method as claimed in claim 16, wherein the phlorotannins also make it possible to stimulate absorption in the plant of one or more elements selected from nitrogen, phosphorus, potassium and calcium.

25. A fertilizing composition, comprising an effective amount of phlorotannins, in particular extracted from brown algae of the family Fucaceae, and optionally in combination with one or more fertilizing substances.

26. The fertilizing composition as claimed in claim 25, wherein the composition is:
in liquid form and contains an amount of phlorotannins of from 0.1 to 100 g per liter; or
in solid form and contains an amount of phlorotannins which allows application of from 10 to 1000 g per hectare.

27. The fertilizing composition as claimed in claim 26, wherein the composition is:
in liquid form and contains an amount of phlorotannins of about 5 g per liter; or
in solid form and contains an amount of phlorotannins which allows application of about 100 g per hectare.

28. The fertilizing composition as claimed in claim 26, wherein the composition is in solid form and in the form of powder or of granules.
